(19) United States
(12) Patent Application Publication
(10) Pub. No.: US 2016/0202812 A1
(43) Pub. Date: Jul. 14, 2016

(54) DISPLAY DEVICE INCLUDING TOUCH SENSOR

(71) Applicant: Samsung Display Co., Ltd., Yongin-city (KR)

(72) Inventor: Joong Bae PYOUN, Cheonan-si (KR)

(21) Appl. No.: 14/730,546

(22) Filed: Jun. 4, 2015

(30) Foreign Application Priority Data
Jan. 12, 2015 (KR) 10-2015-0004339

(51) Int. Cl. G06F 3/047; G09G 5/00

(52) U.S. Cl. CPC G06F 3/047; G09G 5/003; G09G 2300/0426

(57) ABSTRACT

A display device includes: a lower substrate; a display active layer and contact portions disposed on the lower substrate; an upper substrate facing the lower substrate; a touch sensing layer disposed on the upper substrate and including touch electrodes; upper contact portions disposed on the upper substrate and electrically connected with the touch electrodes; and a sealing member configured to combine the lower substrate and the upper substrate, the sealing member including a conductive material configured to electrically connect the upper contact portions and the lower contact portions.

### CROSS-REFERENCE TO RELATED APPLICATION

This application claims priority from and the benefit of Korean Patent Application No. 10-2015-0004339, filed on Jan. 12, 2015, which is hereby incorporated by reference for all purposes as if fully set forth herein.

### BACKGROUND

1. Field

Exemplary embodiments relate to a display device, and more particularly, to a display device including a touch sensor.

2. Discussion of the Background

A flat panel display (FPD), such as an organic light-emitting diode display (OLED) and a liquid crystal display (LCD), includes a display panel including an electric field generating electrode and an electro-optical active layer. Panels of an organic light-emitting diode display (OLED) and a liquid crystal display (LCD) include an organic light-emitting layer and a liquid crystal layer, respectively, as an electro-optical active layer. The electric field generating electrode may be connected to a switching element such as a thin film transistor (TFT) and configured to receive a data signal, and the electro-optical active layer displays an image by converting the data signal into an optical signal.

Such a display device may include a touch sensing function that can interact with a user, in addition to an image display function. When a user touches the screen with one or more fingers or a touch pen, the display device including the touch sensing function may sense a change in a pressure to the screen, an electronic charge, or light and detect touch information, such as whether an object has touched the screen and/or a position of the touch. A display device may receive an image signal based on such touch information.

The touch sensing function may be implemented by including a touch sensor including touch electrodes. As a display panel becomes large-scaled, the number of channels of the touch sensor increases, and thus the number of touch signal lines for transmitting and receiving a signal to and from the touch electrode also increases. Typically, such touch signal lines are designed to be positioned in a peripheral area of a touch area. To reduce a bezel width, a width of the peripheral area should be reduced. However, since the touch signal lines are disposed in the peripheral area, there is a limitation in reducing the width of the peripheral area.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a display device including a touch sensor having advantages of reducing the width of the peripheral area and thus reducing the width of the bezel.

Additional aspects will be set forth in the detailed description which follows, and, in part, will be apparent from the disclosure, or may be learned by practice of the inventive concept.

According to exemplary embodiments, a display device includes: a lower substrate; a display active layer and contact portions disposed on the lower substrate; an upper substrate facing the lower substrate; a touch sensing layer disposed on the upper substrate and including touch electrodes; upper contact portions disposed on the upper substrate and electrically connected with the touch electrodes; and a sealing member configured to combine the lower substrate and the upper substrate, the sealing member including: a conductive material configured to electrically connect the upper contact portions and the lower contact portions.

According to exemplary embodiments, a display device, includes: a lower substrate including: display active layer configured to display image; and touch signal lines; an upper substrate facing the lower substrate, the upper substrate including a display area and a peripheral area; a touch sensing layer disposed on the upper substrate, the touch sensing layer including touch electrodes; upper contact portions disposed in the peripheral area of the upper substrate, the upper contact portions electrically connected with the touch electrodes; lower contact portions disposed on the lower substrate corresponding to the upper contact portions, the lower contact portions connected to the touch signal lines; and a sealing member configured to combine the lower substrate and the upper substrate, the sealing member including: a conductive material configured to electrically connect the upper contact portions and the lower contact portions.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a top plan view schematically showing a display device according to one or more exemplary embodiments.

FIG. 2 is a cross-sectional view taken along sectional line II-II of the display device shown in FIG. 1, according to one or more exemplary embodiments.

FIG. 3 is a top plan view showing a touch sensor of a display device according to one or more exemplary embodiments.

FIG. 4 is an enlarged view of region A in the touch sensor shown in FIG. 3, according to one or more exemplary embodiments.

FIG. 5 is a cross-sectional view taken along sectional line V-V of the touch sensor shown in FIG. 4, according to one or more exemplary embodiments.

FIG. 6 is a cross-sectional view taken along sectional line VI-VI of the touch sensor shown in FIG. 3, according to one or more exemplary embodiments.

FIG. 7 is a view showing a contact portion and a touch signal line that are formed in a lower substrate of the display device according to one or more exemplary embodiments.

FIG. 8 is a cross-sectional view of one pixel formed on a lower substrate in the display device according to one or more exemplary embodiments.

FIG. 9 is a cross-sectional view taken along sectional line II-II of a display device illustrated in FIG. 1, according to one or more exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to, ” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

A display device according to exemplary embodiments will be described in detail with reference to the accompanying drawings. Although exemplary embodiments are described in connection with an organic light-emitting diode display, the exemplary embodiments are not limited thereto, and may be applied to other display devices such as a liquid crystal display device.

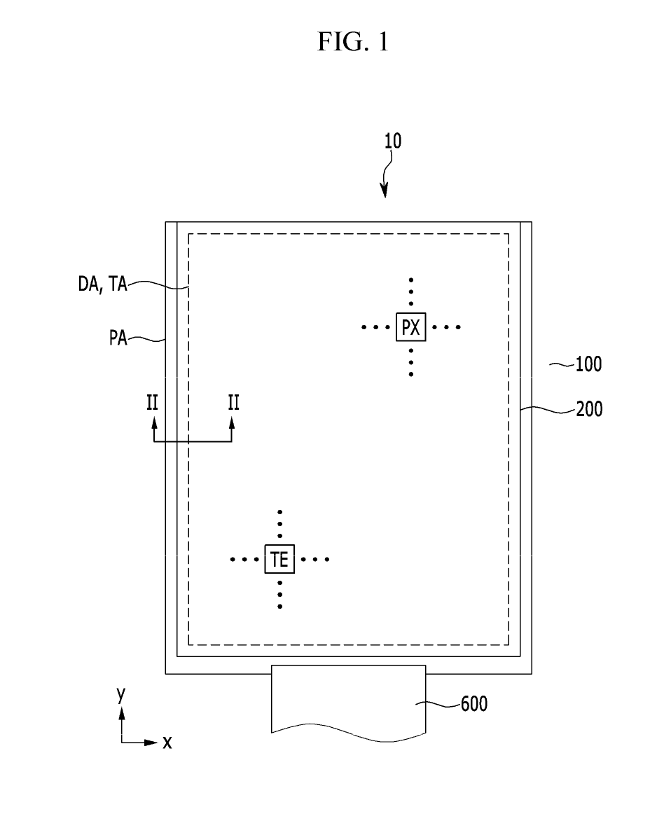

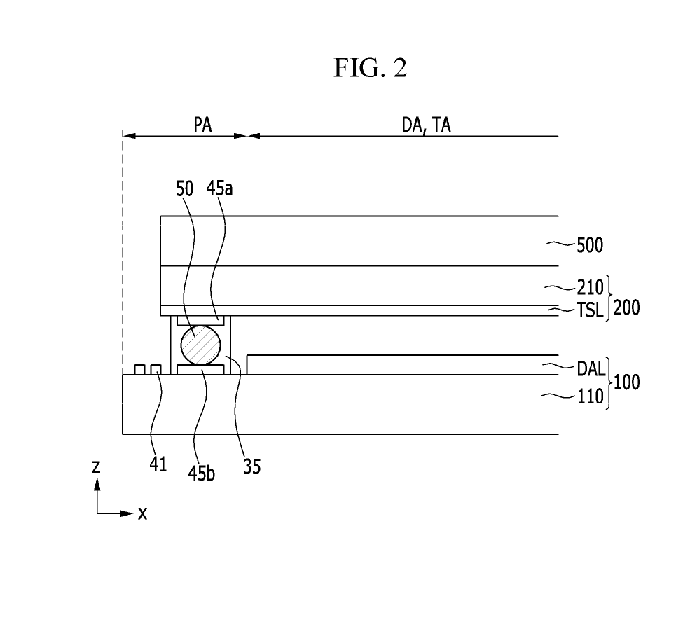

The display device according to one or more exemplary embodiments will be described with reference to FIGS. 1 and 2.

FIG. 1 is a top plan view schematically showing a display device according to one or more exemplary embodiments, and FIG. 2 is a cross-sectional view taken along sectional line II-II of the display device shown in FIG. 1, according to one or more exemplary embodiments.

Referring to FIG. 1, the display device includes a display panel 10. The display panel 10 is configured to display an image and sense a touch. The display panel 10 includes, when viewed from the plane, a display area DA configured to display the image and a peripheral area PA disposed around the display area DA.

At least a part of the display panel 10 may be a touch area TA configured to sense the touch. The touch area TA is an area of the display panel 10 configured to sense the contact and/or close proximity as a touch in response to an object actually coming in contact and/or close proximity with the display panel. The term “contact” used herein denotes a condition in which an external object, such as a hand of a user, directly contacting the display panel 10, as well as a condition in which the external object is or moves in close proximity with the display panel 10 (hovering).

Referring to FIG. 1, the display area DA may substantially match the touch area TA as shown in FIG. 1, but the exemplary embodiments are not limited thereto. For example, the touch area TA may even be in a portion of the peripheral area PA, or may only be in a portion of the display area DA.

Referring to FIGS. 1 and 2, the display panel 10 includes a lower panel 100 and an upper panel 200 facing each other, and the lower panel 100 and the upper panel 200 are combined together.

The upper panel 200 may be smaller than the lower panel 100, and at least one edge of the upper panel 200 may be shorter than a corresponding edge of the lower panel 100. Referring to FIG. 1, exemplary embodiments may include an upper side edge of the upper panel 200 matching a corresponding edge of the lower panel 100, and both side edges and a lower side edge of the upper panel 200 shorter than respectively corresponding edges of the lower panel 100. A flexible circuit board 600, configured to transmit an external signal, is attached to the peripheral area PA of the lower panel 100.

The lower panel 100 includes a lower substrate 110 and a display active layer (DAL) formed thereon. The upper panel 200 includes an upper substrate 210 and a touch sensing layer (TSL) formed thereon. The display active layer (DAL) is disposed on a top surface of the lower substrate 110. The touch sensing layer (TSL) is disposed on a bottom surface of the upper substrate 210, that is, a surface facing the lower substrate 110. According to exemplary embodiments, the TSL may be disposed on a top surface of the upper substrate 210. An anti-reflection layer 500 configured to reduce reflection of external light may be disposed on the upper substrate 210, and the anti-reflection layer may include a linear polarizer, a quarter-wave retarder, etc. When the display panel is a liquid crystal display panel, the display panel may include a polarizer that includes a polarization axis orthogonal to a polarization axis of the lower substrate 110.

The lower substrate 110 and the upper substrate 210 are sealed by a sealing member 35 in the peripheral area PA. The sealing member 35 may surround the display area DA to form a closed curve, and the sealing member 35 combines the lower substrate 110 and the upper substrate 210. When the display panel is a liquid crystal display panel, a liquid crystal layer may be disposed between the lower panel 100 and the upper panel 200. In the organic light-emitting diode panel, the upper substrate 210 may function as an encapsulation substrate configured to restrain or prevent an electro-optical active layer such as a light-emitting device from being exposed to external moisture or oxygen, and thus, protect the electro-optical active layer so that characteristics thereof may not be changed.

The sealing member 35 includes a conductive material, for example, a conductive ball 50. The conductive ball 50 is a conductive particle having a diameter of, for example, several micrometers, and may be formed by plating a plastic particle with a metal material such as nickel and gold. The sealing member 35 may be formed by applying a sealing material including the mixed conductive ball 50 to one of the lower substrate 110 or the upper substrate 210, stacking the other substrate of the lower substrate 110 or the upper substrate 210, and hardening the sealing material. Thus conductive materials (for example, upper and lower contact portions 45a and 45b) that are in contact with a top end and a bottom end of the sealing member 35 are electrically connected through the conductive ball 50.

The lower panel 100 will be described in more detail below.

The display active layer (DAL) is disposed on the lower substrate 110 formed of a transparent insulator such as a glass substrate, and includes pixels and display signal lines (not shown) that are connected with the pixels to deliver driving signals. The DAL is mainly disposed on the display area DA.

The display signal lines include gate lines (not shown) configured to deliver gate signals and data lines (not shown) configured to deliver data signals. Each gate signal line and each data line may extend intersecting each other. The display signal lines may extend to the peripheral area PA to form a pad (not shown).

The pixels may be arranged in the form of a matrix, but is not limited thereto. Each pixel PX includes a switching element connected with the gate line and the data line, and a pixel electrode connected thereto. The switching element may be a three-terminal element, such as a thin film transistor, that is integrated with the lower panel 100. The switching element may be turned on or off in response to a gate signal delivered through the gate line, and thus may selectively deliver a data signal delivered through the data line to a pixel electrode. The pixel PX may further include a common electrode disposed facing the pixel electrode. When the display panel is an organic light-emitting diode panel, a light-emitting layer may be disposed between the pixel electrode and the common electrode to form a light-emitting device. The common electrode may deliver a common voltage. When the display panel is a liquid crystal display panel, a pixel PX may include a liquid crystal layer disposed between the lower substrate 100 and the upper substrate 200, and the common electrode may be disposed on the upper panel 200 or the lower panel 100.

In order to implement color representation, each pixel PX may display one of various primary colors, and a target color may be represented by combining the primary colors. Examples of the primary colors may be three-primary colors, such as red, green, and blue, and may further include white. Each pixel PX is disposed one each corresponding pixel electrode, and may further include a color filter showing one of the primary colors. When the display panel is an organic light-emitting diode panel, the light-emitting layer included in the light-emitting device may emit light representing one of the primary colors.

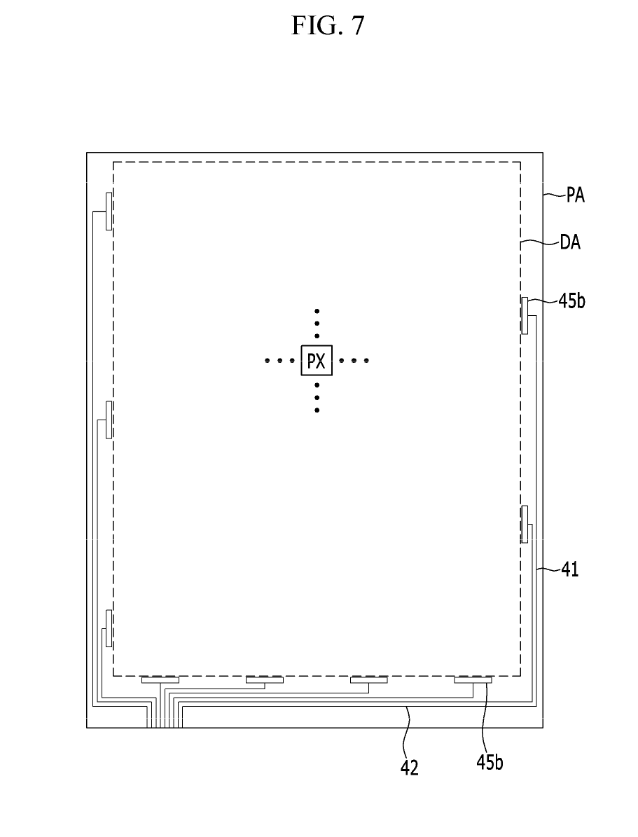

The lower contact portions 45b are disposed on the lower substrate 110 at positions corresponding to those of the upper contact portions 45a, which are described below. The lower contact portion 45b is disposed on a top surface of the lower substrate 110, that is, a surface that faces the upper substrate 210. The lower contact portion 45b is mainly disposed on the peripheral area PA, and is in contact with the conductive ball 50 in the sealing member 35 while overlapping the sealing member 35. A first touch signal line 41 and a second touch signal line 42 (see, e.g., FIG. 7) are also formed in the lower substrate 110, the first and second touch signal lines 41 and 42 are configured to transmit or receive touch signals to or from the touch sensing layer (TSL). Here, the touch signal includes an input signal Tx, that drives the touch sensing layer (TSL) and an output signal Rx that changes in response to a touch applied. The first and second touch signal lines 41 and 42 are mainly disposed in the peripheral area PA, and are connected to the lower contact portion 45b. The first and second touch signal lines 41 and 42 may form a pad (not shown) in the peripheral area PA and may be connected with a touch controller (not shown) configured to transmit a touch signal.

The lower panel 200 will be described in more detail below.

The touch sensing layer (TSL), disposed on the upper substrate 210 made of a transparent insulator such as glass, includes touch electrodes. The touch sensing layer (TSL) is mainly disposed in the touch area TA.

The upper contact portion 45a is formed on the upper substrate 210. The upper contact portion 45a is disposed on a bottom surface of the upper substrate 210, that is, a surface facing the lower substrate 110. The upper contact portion 45a is connected with the touch electrodes included in the touch sensing layer (TSL). At least a portion of the upper contact portion 45a may be in contact with the touch electrodes at an edge of the touch sensing layer (TSL). The upper contact portion 45a is mainly disposed in the peripheral area PA, and is in contact with the conductive ball 50 in the sealing member 35 while overlapping the sealing member 35. Accordingly, the upper contact portion 45a is electrically connected, through the conductive ball 50, with the lower contact portion 45b, that is disposed in a corresponding position of the lower substrate 110.

Since the upper contact portion 45a is connected with the touch electrode and the lower contact portion 45b is connected with the first and second touch signal lines 41 and 42, the touch electrode is electrically connected with the first and second touch signal lines 41 and 42 through the electrical connections of the upper contact portion 45a and the lower contact portion 45b. Accordingly, the touch electrodes formed on the upper substrate 210 may communicate the touch signal between the touch controller through the first and second touch signal lines 41 and 42 formed on the lower substrate 110. Since the first and second touch signal lines 41 and 42 configured to transmit touch signals are disposed on the lower substrate 110, the first and second touch signal lines 41 and 42 are not formed on the upper substrate 310. Accordingly, a width of the peripheral area PA of the upper substrate 210 may be reduced. Since a width of a bezel is dependent on the width of the peripheral area PA, and the upper substrate 210 including the touch sensing layer (TSL) typically faces toward front of the display device, the width of the bezel recognized from the front of the display device may be reduced by reducing the width of the peripheral area PA of the upper substrate 210.

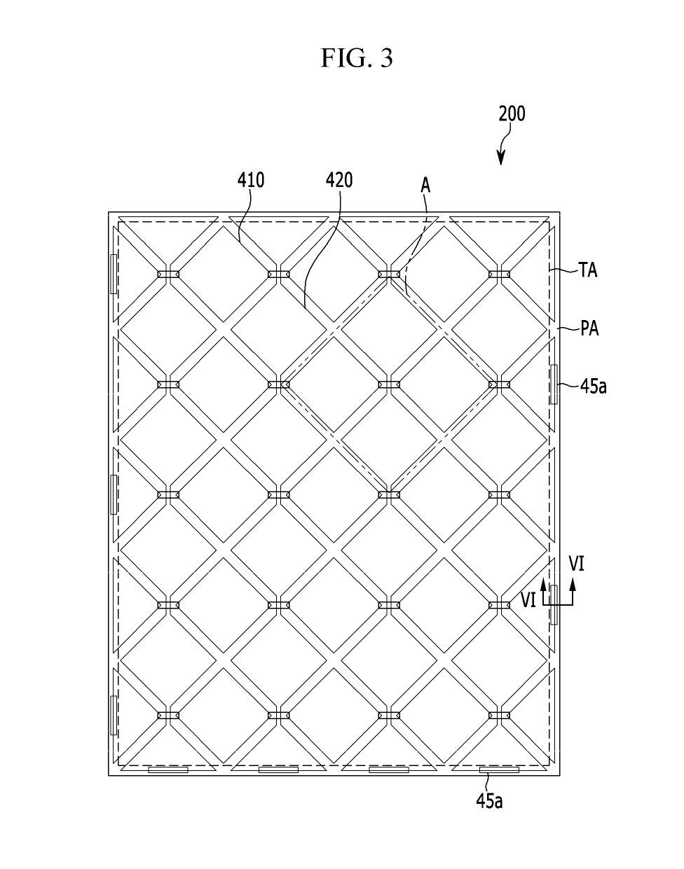

A touch sensor of a display device according to exemplary embodiments will be described in more detail with reference to FIGS. 3, 4, 5, 6, and 7.

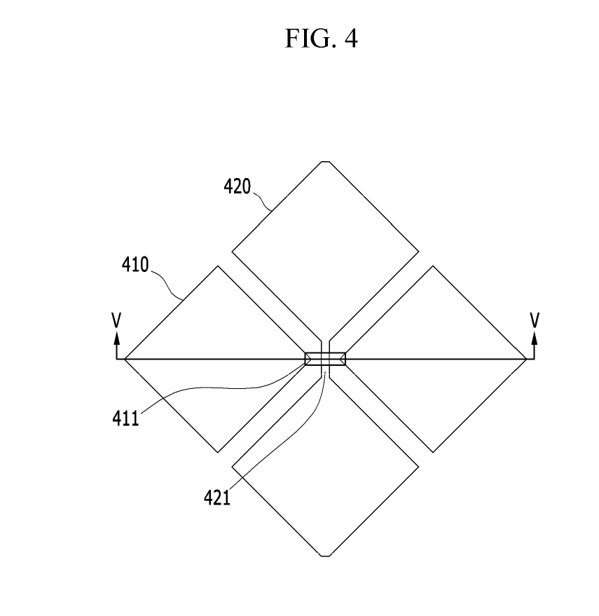

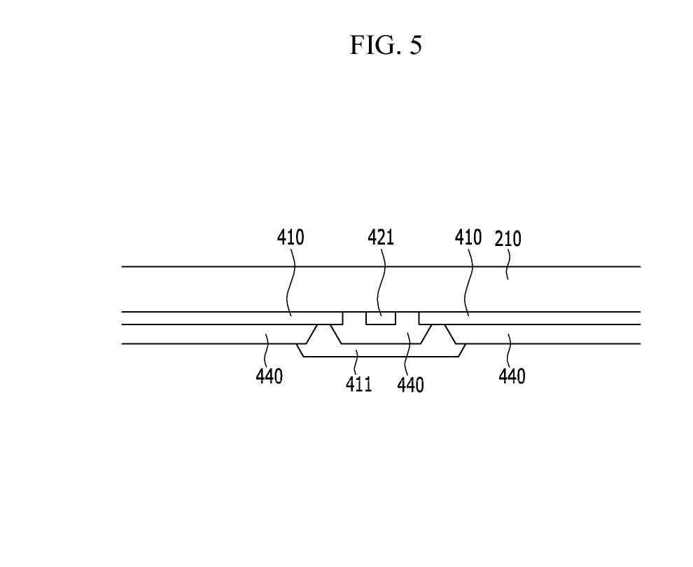

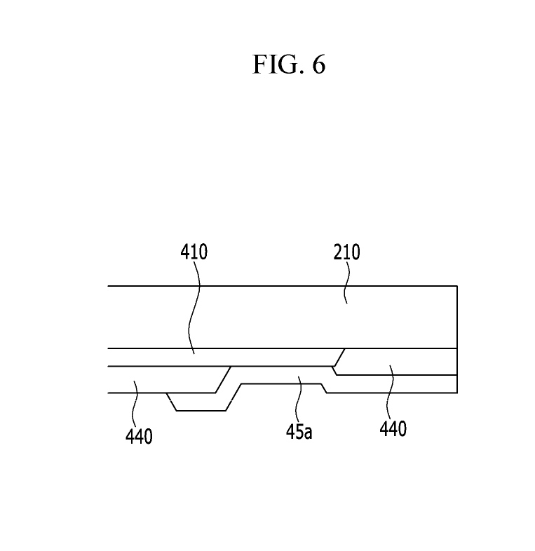

FIG. 3 is a top plan view showing a touch sensor of a display device according to one or more exemplary embodiments, FIG. 4 is an enlarged view of region A in the touch sensor shown in FIG. 3, according to one or more exemplary embodiments, and FIG. 5 is a cross-sectional view taken along sectional line V-V of the touch sensor shown in FIG. 4, according to one or more exemplary embodiments. FIG. 6 is a cross-sectional view taken along sectional line VI-VI of the touch sensor shown in FIG. 3, according to one or more exemplary embodiments. FIG. 7 is a view showing a contact portion and a touch signal line that are formed in a lower substrate of the display device according to one or more exemplary embodiments.

The touch sensor may be configured to sense a contact in various manners. The touch sensor may be classified as a resistive type sensor, a capacitive type sensor, an electro-magnetic type sensor, an optical type sensor, etc. Here, an exemplary embodiment relates to a capacitive type touch sensor as an example.

Referring to FIG. 3, a touch sensor formed on the upper substrate 210 includes first touch electrodes 410 and second touch electrodes 420. The first and second touch electrodes 410 and 420 form a touch sensing layer (TSL). The first touch electrodes 410 and the second touch electrodes 420 are separated from each other.

The first touch electrodes 410 and the second touch electrodes 420 are alternately disposed so as to not overlap each other in the touch area TA. The first touch electrodes 410 are disposed in column and row directions, and the second touch electrodes 420 are also disposed in column and row directions.

The first touch electrodes 410 and the second touch electrodes 420 are disposed in the same layer, but may be disposed in different layers. In general, the first touch electrode 410 and the second touch electrode 420 have, but not limited to, the shape of a quadrangle, and may have the shape of a polygon such as a hexagon, a circle, and/or an ellipse and may have various shapes such as a protrusion part for improving sensitivity of the touch sensor.

At least some of the first touch electrodes 410 arranged in the same row or column may be connected to or separated from each other disposed in inside or outside the touch area TA. Likewise, at least some of the second touch electrodes 420 arranged in the same row or column may be connected to or separated from each other disposed in inside or outside the touch area TA. For example, as shown in FIG. 3, the first touch electrodes 410 disposed in the same row may be connected to each other in the touch area TA, and the second touch electrodes 420 disposed in the same column may be connected to each other in the touch area TA. That is, the first touch electrodes 410 that are disposed in each row may be connected to each other through a first connector 411, forming an electrode row, and the second touch electrodes 420 that are disposed in each column may be connected to each other through a second connector 421, forming an electrode column.

Referring to FIGS. 4 and 5, the first and second touch electrodes 410 and 420, and the second connector 421 configured to connect adjacent second touch electrodes 420, are disposed on the upper substrate 210, and a first insulating layer 440 is formed thereon. The first connector 411, configured to connect adjacent first touch electrodes 410, is formed on the insulating layer 440. An insulating layer (not shown) for protecting the first connector 411 may be formed on the first connector 411.

The first connector 411 is configured to electrically connect the first touch electrodes 410 through a contact hole formed in the insulating layer 440. A portion of the first connector 411 overlaps the second connector 421, but is physically and electrically separated by the insulating layer 440. The first touch electrode 410, the second touch electrode 420, and the second connector 421 may be formed of the same material, and may be patterned simultaneously. The first connector 411 may be formed of the same material as the upper contact portion 45a, and may be patterned simultaneously.

According to the exemplary embodiments, the first connector 411 may be disposed on the upper substrate 210, the insulating layer 440 may be disposed on the first connector 411 and the upper substrate 210, and the first and second touch electrodes 410 and 420 and the second connector 421 may be disposed thereon. According to the exemplary embodiments, the first connector 411 configured to connect adjacent first touch electrodes 410 may be disposed in the same layer integrated with the first touch electrode 410, and the second connector 421 configured to connect adjacent second touch electrodes 420 may be disposed in a different layer from the second touch electrode 420. According to the exemplary embodiments, the connection between the touch electrodes may have various modifications.

Referring to FIGS. 3 and 6, the upper contact portion 45a is formed over the touch electrodes 410 and 420 that are disposed near an edge of the upper substrate 210. The upper contact portion 45a may partially overlap the touch electrodes 410 and/or 420 as shown, and may also entirely overlap the first touch electrode 410. The insulating layer 440 may be formed over the touch electrodes 410 and/or 420 that are disposed near the edge, and the upper contact portion 45a may be in contact with the touch electrodes 410 and/or 420 via a contact hole formed by removing a portion of the insulating layer 440.

The upper contact portion 45a may be disposed over the first touch electrodes 410 disposed at one of both ends of electrode rows, and/or may be formed over the first touch electrodes 410 disposed at both ends. When the upper contact portion 45a may be formed over the first touch electrodes 410 disposed at one of both ends of electrode rows, the upper contact portion 45a may be alternately disposed on a first touch electrode 410 at a left end and a right end of each electrode rows. The upper contact portion 45a may be disposed over the second touch electrodes 420 disposed at one of both ends of electrode columns, and/or may be formed over the second touch electrodes 420 disposed at both ends. Although FIG. 3 illustrates that the upper contact portion 45a is formed over the second touch electrode 420 disposed at a bottom end of the electrode columns, the upper contact portion 45a may also be formed on the second touch electrode 420 disposed at a top end of the electrode columns.

Referring back to FIG. 2, the upper contact portion 45a overlaps the sealing member 35 that may be approximately disposed along an edge of the upper substrate 210. The upper contact portion 45a may be formed to extend along the sealing member 35 having a width substantially similar to the sealing member 35, in order to include increased contact area with the conductive ball 50 within the sealing member 35. The peripheral area PA of the upper substrate 210 may only include the upper contact portion 45a and the sealing member 35 overlapping the upper contact portion 45a, thus the peripheral area PA of the upper substrate 210 may be decreased compared to a peripheral area PA according to comparative arts that includes the first and second touch signal lines 41 and 42 disposed on the upper substrate 210.

Referring to FIG. 7, the lower contact portion 45b is formed in the peripheral area PA of the lower substrate 110, the pixel PX is disposed in the display area DA of the lower substrate 110, and the lower contact portion 45b is connected with the first and second touch signal lines 41 and 42. The first and second touch signal lines 41 and 42 are mainly disposed in the peripheral area PA as shown, but may be formed in the display area DA. The first and second touch signal lines 41 and 42 may be disposed on a top surface or bottom surface of the lower substrate 110. When the first and second touch signal lines 41 and 42 are disposed on the bottom surface of the lower substrate 110, the first and second touch signal lines 41 and 42 are electrically connected to the lower contact portion 45b by forming a through hole in the lower substrate 110 and filling an electric conductor into the through hole.

The lower contact portion 45b may be formed in a position and have a size corresponding to those of the upper contact portion 45a. That is, the lower contact portion 45b may substantially overlap the upper contact portion 45a. Referring back to FIG. 2, the lower contact portion 45b overlaps the sealing member 35 that may be formed to extend approximately along an edge of the lower substrate 45, and be in contact with the conductive ball 50 in the sealing member 35. Accordingly, the first and second touch electrodes 410 and 420 that are in contact with the upper contact portion 45a may be electrically connected with the lower contact portion 45b through the conductive ball 50, and in turn, be electrically connected with the first and second touch signal lines 41 and 42 that are connected with the lower contact portion 45b. The first touch electrode 410 in each electrode row is connected to the first touch signal line 41, and the second touch electrode 420 in each electrode column is connected to the second touch signal line 42. Accordingly, the first touch electrode 410 is connected with the touch controller through the first touch signal line 41, and the second touch electrode 420 is connected with the touch controller through the second touch signal line 42.

At one end of each of the first and second touch signal lines 41 and 42, a pad (not shown) for the touch sensing layer (TSL) may be formed in the peripheral area of the lower substrate 110. A flexible circuit board 600, configured to transmit an external signal to the touch sensing layer (TSL), may be attached to the pad, and the flexible circuit board 600 is also attached to a pad (not shown) of a display signal line configured to transmit the external signal to the display active layer (DAL). According to exemplary embodiments, the flexible circuit board may be attached to the pad of the touch signal line and the pad of the display signal line. According to comparative arts, the flexible circuit board may be attached to the upper substrate 210 and the lower substrate 110, and the interference between the upper substrate 210 and the lower substrate 110 may cause a crack and/or noise in the flexible circuit board, and thus, an addition space should be secured in order to prevent such interference. According to the exemplary embodiments, one flexible circuit board or both of two flexible circuit boards may be attached to the lower substrate 110, and thus, the above problem may be reduced or prevented.

The upper contact portion 45a may be formed of a low resistance material including at least one of molybdenum (Mo), silver (Ag), titanium (Ti), copper (Cu), aluminum (Al), and molybdenum/aluminum/molybdenum (Mo/Al/Mo). The lower contact portion 45b and the first and second touch signal lines 41 and 42 may be formed of the above-described material regarding the upper contact portion 45a. The lower contact portion 45b and the touch signal line 41 or 42 may be integrally formed of the same material, or separately formed and electrically connected to each other. The first and second touch electrodes 410 and 420 are formed of a transparent conductive oxide (TCO) including at least one of an indium tin oxide (ITO) and an indium zinc oxide (IZO) or a conductive material including at least one of a silver nano wire (AgNW), a metal mesh, and a carbon nanotube (CNT). However, the exemplary embodiments are not limited thereto.

The first touch electrode 410 and the second touch electrode 420 that are adjacent to each other may form a mutual capacitor that functions as the touch sensor. The mutual capacitor may receive a driving signal through one of the first touch electrode 410 and the second touch electrode 420 and transmit a sensing signal according to a change in the amount of electric charges due to a touch of an external object through the other touch electrode.

The exemplary embodiments are not limited to FIGS. 3, 4, and 5, and the first touch electrodes 410 may be formed separately from each other and the second touch electrodes 420 may also be formed separately from each other to form independent touch electrodes. According to the exemplary embodiments, each touch electrode may form a self-capacitor as a touch sensor, may be configured to receive a driving signal and be charged with a predetermined amount of electric charges, and may be configured to output a sensing signal different from the received driving signal in response to a change to the charged amount of electric charges due to an external object such as a finger comes in contact.

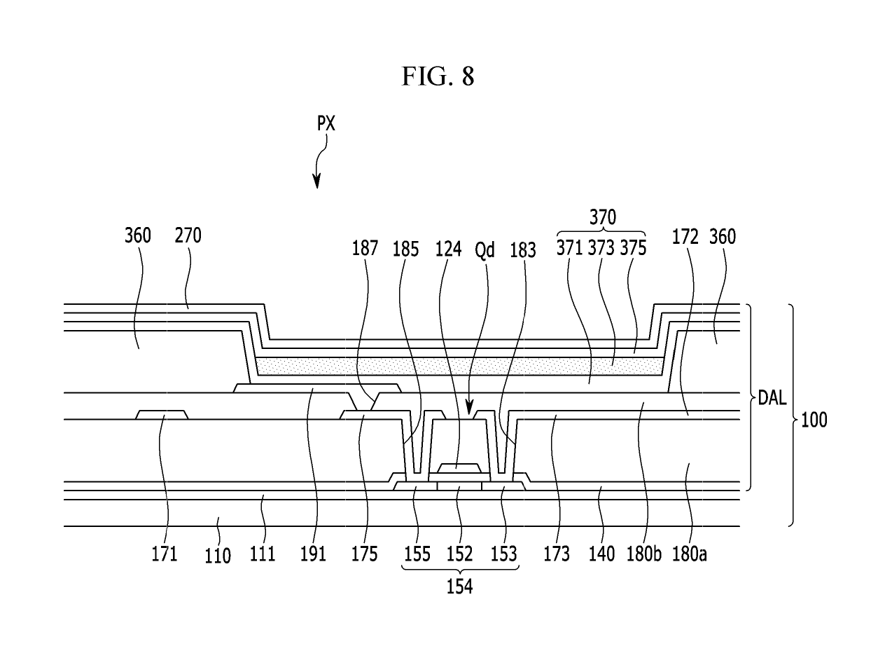

FIG. 8 is a cross-sectional view of one pixel formed on a lower substrate in the display device according to one or more exemplary embodiments.

The display device includes a lower substrate 110 and multiple layers disposed thereon. A buffer layer 111 may be disposed directly on the lower substrate 110.

The lower substrate 110 is made of a transparent insulation material including at least one of glass, plastic, and the like. For example, the lower substrate 110 may be formed of borosilicate glass having a heat resistance temperature of 600° C. or higher. The lower substrate 110 may be a plastic substrate formed of plastic including at least one of polyethylene terephthalate (PET), polyethylene naphthalate (PEN), and polyimide (PI). The plastic substrate may be a flexible substrate.

The buffer layer 111 may reduce or prevent diffusion of impurity which may damage or degrade characteristics of semiconductor, reduce or prevent infiltration of moisture or outdoor air, and planarize the upper surface. The buffer layer 111 may be referred to as a blocking layer or a barrier layer. The buffer layer 111 may include at least one of a silicon nitride (SiNx), a silicon oxide (SiOx), and the like, and may be formed in a single layer or multiple layers. The buffer layer 111 may be omitted depending on a substrate type or a process condition.

The display active layer (DAL) including multiple layers of thin films is disposed on the buffer layer 111.

The display active layer (DAL) includes several kinds of signal lines, such as the above-described gate line and data line, and pixels.

An exemplary display active layer according to exemplary embodiments will be described with reference to FIG. 8. Semiconductors 154 may be disposed on the buffer layer 111. The semiconductors 154 may include a channel region 152, a source region 153 and a drain region 155. The source region 153 and the drain region may be formed of doped semiconductor, and disposed at both sides of the channel region 152. The semiconductors 154 may include at least one of amorphous silicon, polycrystalline silicon, and oxide semiconductor.

A gate insulting layer 140, that may be formed of an inorganic insulator including at least one of a silicon nitride, a silicon oxide, and a silicon oxynitride, is disposed on the semiconductors 154.

Gate conductors including gate lines (not shown) and a control electrode 124 are disposed on the gate insulating layer 140. The control electrode 124 may overlap a portion of the semiconductors 154, particularly, the channel region 152 of the semiconductor 154.

A first passivation film 180a is disposed on the gate insulating layer 140 and the gate conductors including the gate lines (not shown) and the control electrode 124. The first passivation film 180a and the gate insulating layer 140 include a contact hole 183 that exposes the source region 153 of the semiconductors 154 and a contact hole 185 that exposes the drain region 155.

Data conductors including data lines 171, input electrodes 173, and output electrodes are disposed on the first passivation film 180a. The data lines 171 may be configured to deliver data signals and be disposed intersecting the gate lines. The input electrode 173 is connected with the data lines 171. The output electrode 175 is separated from the data lines 171. The input electrode 173 and the output electrode 173 are disposed facing each other with respect to the semiconductors 154.

The input electrode 173 and the output electrode 175 may be respectively connected with the source region 153 and the drain region 155 of the semiconductors 154 respectively through the contact holes 183 and 185.

The control electrode 124, the input electrode 173, and the output electrode 175 together with the semiconductors 154 may form a driving thin film transistor Qd. However, structures of the driving thin film transistor Qd according to the exemplary embodiments are not limited thereto, and may be variously changed.

A second passivation film 180b, that may be formed of an inorganic Insulator including at least one of a silicon nitride and a silicon oxide, is disposed on the data conductors. The second passivation film 180b may have a flat surface with reduced step difference in order to increase a light-emitting efficiency of a light-emitting member that is to be disposed on the second passivation film 180b. A contact hole 182 is formed on the second passivation film 180b exposing the output electrode 175.

Pixel electrodes 191 are disposed on the second passivation film 180b. A pixel electrode 191 of each pixel is physically and electrically connected with the output electrode 175 through the contact hole 187 of the second passivation film 180b. The pixel electrode 191 may include a transflective conductive material and/or a reflective conductive material.

A pixel defining film 360 (or a partition wall), having openings configured to expose the pixel electrodes 191, is disposed on the second passivation film 180b. The openings of the pixel defining film 360 configured to expose the pixel electrodes 191 may define respective pixel regions. The pixel defining film 360 may be omitted.

A light-emitting member 370 is disposed on the pixel defining film 360 and the pixel electrodes 191. The light-emitting member 370 includes a first organic common layer 371, light-emitting layer 373, and a second organic common layer 365 sequentially stacked.

The first organic common layer 371 may include at least one of a hole injecting layer (HIL) and a hole transport layer (HTL). The first organic common layer 371 may include both of the hole injecting layer (HIL) and the hole transport layer (HTL), sequentially stacked. The first organic common layer 371 may be formed on an entire surface of the display area in which pixels are disposed, or may be formed only on the pixel regions.

The light-emitting layers 373 may be disposed on pixel electrodes 191 of respective corresponding pixels. The light-emitting layer 373 may have a structure including an organic material configured to emit light having one of primary colors such as red, green, and blue, and a structure including organic material layers stacked, each organic material layers configured to emit light having different colors respectively.

The second organic common layer 375 may include at least one of an electron transport layer (ETL) and an electron injecting layer (EIL). The second organic common layer 375 may include both of the electron transport layer (ETL) and the electron injecting layer (EIL), sequentially stacked.

The first and second organic common layers 371 and 375 may be configured to enhance a light-emitting efficiency of the light-emitting layers, and at least one of the first and second organic common layers 371 and 375 may be omitted.

A common electrode 270, configured to deliver a common voltage, is disposed on the light-emitting member 370. The common electrode 270 may include a transparent conductive material. For example, the common electrode 270 may be formed of a transparent conductive material including at least one of ITO and IZO, and/or formed by stacking thin metal layer including at least one of calcium (CA), barium (Ba), magnesium (Mg), aluminum (Al), and silver (Ag) having a light transmittance. The common electrode 270 may have a double layer structure including a metal layer and a transparent conductive material layer. An insulating layer (not shown) may be further disposed on the common electrode 270.

The pixel electrode 191, the light-emitting member 370, and the common electrode 270 of each pixel form a light-emitting device. Among the pixel electrode 191 and the common electrode 270, one performs as a cathode, and the other performs as an anode. For example, the pixel electrode 191 may be the anode, and the common electrode 270 may be the cathode.

The display device may be a top emission type device, which is configured to emit light from the light-emitting member 370 upwards to display an image.

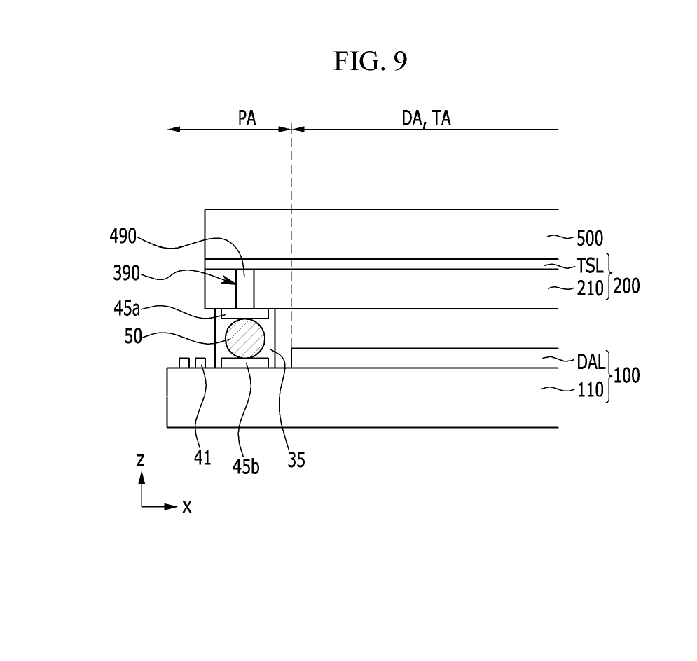

FIG. 9 is a cross-sectional view taken along sectional line II-II of a display device illustrated in FIG. 1, according to one or more exemplary embodiments.

Referring to FIG. 9, the touch sensing layer (TSL) is disposed in different position compared to the display device illustrated in FIG. 2. Thus the exemplary embodiment of FIG. 9 is slightly different from the exemplary embodiment shown in FIG. 2. Specifically, the upper contact portion 45a is disposed on a bottom surface of the upper substrate 210 facing the lower substrate 110, and the touch sensing layer (TSL) may be formed on a top surface of the upper substrate 210 opposite to the bottom surface of the upper substrate 210. In this case, disposed on different surfaces, The upper substrate 210 include a through hole 390 overlapping the upper contact portion 45a and the touch sensing layer (TSL) and a conductor 409 filled in the through hole 390, configured to electrically connect the upper contact portion 45a and the touch sensing layer (TSL). The conductor 409 may be a metal material filled into the though hole 390 using, for example, a liquid metal inkjet method. A top end of the conductor 490 is connected to the first and second touch electrodes 410 and 420 of the touch sensing layer (TSL), and a bottom end of the conductor 490 is electrically connected to the lower contact portion 45b and the first and second touch electrodes 410 and 420 and the lower contact portion 45b may be electrically connected. The description provided in relation to FIG. 2 may be applied to other components of the display device and the correlations therebetween.

According to exemplary embodiments, the touch signal lines of the touch sensor are formed on the lower substrate and thus the peripheral area of the upper substrate may be minimized to reduce a bezel width. In addition, a flexible circuit board for the touch sensor need not be prepared separately, and thus a cost may be saved and interference between the flexible circuit board for the touch sensor and a flexible circuit board for a display sensor may not be generated.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A display device, comprising:
a lower substrate;
a display active layer and lower contact portions disposed on the lower substrate;
an upper substrate disposed facing the lower substrate;
a touch sensing layer disposed on the upper substrate, the touch sensing layer comprising touch electrodes;
upper contact portions disposed on the upper substrate, the upper contact portions electrically connected with the touch electrodes; and
a sealing member configured to combine the lower substrate and the upper substrate, the sealing member comprising: a conductive material configured to electrically connect the upper contact portions and the lower contact portions.

2. The display device of claim 1, further comprising touch signal lines configured to communicate signals with the touch electrodes, the touch signal lines disposed on the lower substrate.

3. The display device of claim 2, wherein the touch signal lines are electrically connected with the lower contact portions.

4. The display device of claim 3, wherein the touch sensing layer comprises:
first touch electrodes;
second touch electrodes;
first connectors configured to connect the first touch electrodes in a first direction; and
second connectors configured to connect the second touch electrodes in a second direction crossing the first direction.

5. The display device of claim 4, wherein the touch sensing layer further comprises an insulating layer disposed between the first connectors and the second connectors.

6. The display device of claim 5, wherein the upper contact portions are formed of the same material as the first connectors or the second connectors.

7. The display device of claim 6, wherein the upper contact portions are formed of a metal material.

8. The display device of claim 6, wherein the first and the second touch electrodes are formed of a transparent conductive material, and
the first connector or the second connector is formed of a transparent conductive material.

9. The display device of claim 1, wherein the upper contact portions overlap the lower contact portions.

10. The display device of claim 1, wherein the conductive material is a conductive ball comprising a plastic particle and a metal plating.

11. The display device of claim 1, wherein the touch sensing layer and the upper contact portions are disposed on a surface the upper substrate facing the lower substrate.

12. The display device of claim 11, wherein the upper contact portions are configured to be in contact with the touch electrodes.

13. The display device of claim 1, wherein the touch sensing layer is formed on a surface of the upper substrate opposite to a surface facing the lower substrate, and
the upper contact portions are formed on the surface facing the lower substrate.

14. The display device of claim 13, wherein the upper substrate comprises:
through holes; and
connectors disposed within the through holes, the connectors configured to electrically connect the upper contact portions with the touch electrodes.

15. A display device, comprising:
a lower substrate comprising:
display active layer configured to display image; and
touch signal lines;
an upper substrate facing the lower substrate, the upper substrate comprising a display area and a peripheral area;
a touch sensing layer disposed on the upper substrate, the touch sensing layer comprising touch electrodes;
upper contact portions disposed in the peripheral area of the upper substrate, the upper contact portions electrically connected with the touch electrodes;
lower contact portions disposed on the lower substrate corresponding to the upper contact portions, the lower contact portions connected to the touch signal lines; and
a sealing member configured to combine the lower substrate and the upper substrate, the sealing member comprising: a conductive material configured to electrically connect the upper contact portions and the lower contact portions.

16. The display device of claim 15, wherein the touch sensing layer is configured to generate a touch signal, and
the touch signal lines are configured to communicate the touch signal from the touch sensing layer.

17. The display device of claim 15, wherein the touch sensing layer comprises:
first touch electrodes;
second touch electrodes;
first connectors configured to connect the first touch electrodes in a first direction; and
second connectors configured to connect the second touch electrodes in a second direction crossing the first direction.

18. The display device of claim 15, wherein the conductive material is a conductive ball comprising a plastic particle and a metal plating.

19. The display device of claim 15, wherein the touch sensing layer and the upper contact portions are disposed on a surface the upper substrate facing the lower substrate.

20. The display device of claim 15, wherein the touch sensing layer is formed on a surface of the upper substrate opposite to a surface facing the lower substrate,
the upper contact portions are formed on the surface facing the lower substrate, and
the upper substrate comprises:
through holes; and
connectors disposed within the through holes, the connectors configured to electrically connect the upper contact portions with the touch electrodes.
